(19) United States
(12) Patent Application Publication
(10) Pub. No.: US 2013/0275309 A1
(43) Pub. Date: Oct. 17, 2013

(54) Electronic-payment authentication process with an eye-positioning method for unlocking a pattern lock

(71) Applicant: Francis King Hei KWONG, Hong Kong (HK)

(72) Inventor: Francis King Hei KWONG, Hong Kong (HK)

(21) Appl. No.: 13/859,711

(22) Filed: Apr. 9, 2013

(30) Foreign Application Priority Data
Apr. 13, 2012 (HK) 12103676.1

(51) Int. Cl. G06Q 20/40; H04N 7/18

(52) U.S. Cl. CPC G06Q 20/40145; H04N 7/18
USPC 705/71; 705/44; 348/78

(57) ABSTRACT

This invention discloses an eye-positioning method for unlocking a pattern lock by a user, comprising: showing to the user a pattern diagram on a display, the pattern diagram being pre-stored in a storage device at a back-end server, and is transmitted to the display via a network; capturing a facial image of the user by a video-taking equipment coupled to the display; an on-screen marker real-time tracking an eye of the payer, enabling the marker to move on the pattern diagram to form a marker-movement path according to movement of the eye relative to the video-taking equipment, the eye being either a left eye or a right eye as pre-agreed; and determining if the marker-movement path includes an entirety of a pre-set action path. This invention also provides an electronic-payment authentication method using the aforementioned pattern-unlocking method, for payments at retail sites and for online payments.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCE TO RELATED APPLICATIONS

This application claims priority on Hong Kong Short-Term Patent Application No. 12103676.1 filed 13 Apr. 2012, the disclosure of which is incorporated by reference herein.

### FIELD OF THE INVENTION

The present invention relates to an electronic-payment authentication process with an eye-based method for unlocking a pattern lock. In particular, this invention relates to a mobile payment system that is highly secured, suitable for daily payment at physical retail sites and in online shopping.

### BACKGROUND

Currently, a wide variety of payment methods are available for consumers. In addition to cash, credit cards, debit cards, prepaid cards, merchant cash points and cash coupons are widely used. The popularity of online shopping also promotes the development of online payment technologies.

One worrying problem is the security of various payment cards. Usually, only one signature or one password together with a card are sufficient to authorize a purchase transaction involving a large amount of money. This security problem of credit cards is particularly concerned. Key information of a credit card includes card number, card holder's name, expiry date and signature, all of which are clearly displayed on both sides of the credit card. A credit card payment slip also has such key information. In case of loss or disclosure of such information, a thief can easily reproduce a counterfeit card or pay for online shopping using the stolen card information, resulting financial loss suffered by the card holder or the bank. Credit card security has long been criticized, mainly because current authentication process is weak against impersonation. Investigation of credit card theft cases is also very difficult. One key problem is that issuing banks of credit cards have great difficulty to identify transactions made by the thieves before loss of credit cards is reported.

Recently, some technology companies have developed electronic payment systems running on smart phones. However, none of these systems implements triple authentication process. The scenario supported by such systems is limited only to mobile payment at physical retail sites. These systems do not support online purchases (including purchases made through the phone or Internet).

### SUMMARY OF THE INVENTION

In order to address the issues of security weakness, convenience and environmentally friendliness with current payment systems, a novel electronic-payment authentication process with an eye-positioning method for unlocking a pattern lock is invented.

A first aspect of this invention is a method that uses an eye to unlock a pattern lock. The method comprises: showing to the user a pattern diagram on a display, wherein the pattern diagram is pre-stored in a storage device at a back-end server, and is transmitted to the display via a network; capturing a facial image of the user by a video-taking equipment coupled to the display; real-time tracking an eye of the user based on the facial image, enabling a marker to move on the pattern diagram to form a marker-movement path according to movement of the eye relative to the video-taking equipment, wherein the eye is either a left eye or a right eye as pre-agreed; and determining if the marker-movement path includes an entirety of a pre-set action path, whereby the pattern lock is unlocked if a positive result is obtained in such determining.

Preferably, the pattern diagram comprises a plurality of rings, wherein the user determines the number of the rings and a combination of the rings to form the pattern diagram.

Preferably, the marker-movement path is formed by hopping among the rings, hopping on any one of the rings with more than one time being allowable.

The marker-movement path may be alternatively formed by moving a finger on a touch screen incorporated in the display instead of being formed according to the movement of relative position between the eye and the video-taking equipment.

A second aspect of the present invention is an electronic-payment authentication method based on the method disclosed according to the first aspect of this invention. The electronic-payment authentication method as disclosed in the second aspect comprises: establishing communication links among an electronic-payment user device, an electronic-payment system, and a financial institution; determining, by the electronic-payment system, if a payer is registered to use the electronic-payment user device, in order to confirm the payer's identity and validity of a payment made by the payer; transmitting a pattern diagram from the electronic-payment system to the electronic-payment user device, and requesting the payer to unlock a pattern lock associated with the pattern diagram in order to further confirm the payer's identity, wherein the pattern diagram is pre-stored in the electronic-payment system and is displayed on the electronic-payment user device; and unlocking, by the payer, the pattern lock according to the method disclosed in the first aspect of this invention, wherein the payer is regarded as the user.

Preferably, the electronic-payment authentication method further comprises: after the payer's identity and the validity of a payment made by the payer are confirmed, comparing, by a merchant, the payer's actual facial appearance with the payer's recent photos as recorded in the electronic-payment system, in order to further confirm the payer's identity.

The electronic-payment user device may be a smart mobile device used by the payer to make a payment at a physical retail site, via a phone call or on the Internet. Optionally, the smart mobile device may be a smart phone or a tablet computer. Alternatively, this device may be a Radio-Frequency Identification (RFID) card that supports reading and writing of RFID Card Number stored therein, the RFID card being used by the payer to make a payment at a retail site.

If the smart mobile device is used as the electronic-payment user device to make a payment at a physical retail site, the electronic-payment user device may be enabled to generate, by software, a Payment Approval Code, which is computed by using a regularly-changed asymmetric key pair to encrypt and decrypt a composite data set formed according to the payer's identity, and time and date of encryption, so as to enable the electronic-payment system to approve the payment if: successful decryption is achieved; the payer's identity matches a corresponding record in the electronic-payment system; and the time and date of encryption are not expired.

The RFID Card Number may include a payer identification number stored in the RFID card, and a serial number configured to be regularly updated by the electronic-payment system each time when any merchant's mobile video terminal senses the RFID card, so as to enable the electronic-payment system to approve the payment if both the payer identification number and the serial number match corresponding records of the electronic-payment system.

When the smart mobile device is used as the electronic-payment user device at the physical retail site, the Payment Approval Code may be transmitted from the smart mobile device to the physical retail site's side by means of a text, by a two-dimensional barcode or through NFC (Near Field Communication).

The merchant, in addition to comparing the payer's actual facial appearance with the payer's recent photo, may further compare the payer's actual facial appearance with the payer's one or more past photos recorded by the electronic-payment system if the payer has one or more previous payments using the system.

Each payment record in the electronic-payment system is attached with the payer's photo for identifying the payer for theft investigation purposes.

The video-taking equipment used for video-taking the payer's facial appearance, resides in the electronic-payment user device. Furthermore, the electronic-payment system may include an eye-tracking control module coupled to the video-taking equipment, the eye-tracking control module being configured to detect the eye's position by an object-recognition algorithm according to the payer's facial appearance obtained by the video-taking equipment such that the marker's position is determined by the eye's position.

The pattern lock unlocking method and the electronic-payment authentication process as disclosed herein allows unlocking the pattern lock by using an eye, making this unlocking more secure than the existing finger-based unlocking approaches. Furthermore, since using the left eye or the right eye and using which pattern diagram are defined by the user, the unlocking pattern is more resistant to theft, thereby enhancing the security level in making payment anytime and anywhere. The disclosed methods can be adopted by existing commonly-used equipment, increasing cost-effectiveness of payment processing by financial institutions (e.g., banks) and merchants and also favoring environmental protection.

### BRIEF DESCRIPTION OF THE DRAWINGS

FIG. 1 depicts a schematic diagram of an anti-theft mobile e-payment system in accordance with one embodiment of the present invention.

FIG. 2 is an example of recorded information in the anti-theft mobile e-payment system in accordance with one embodiment of this invention.

FIG. 3 is a flowchart illustrating, according to one embodiment of this invention, a stage of selecting payment card(s) for payment and making the payment at the cashier through the payer's smart mobile device.

FIG. 4 is a flowchart illustrating, according to one embodiment of this invention, a stage of confirmation at the cashier for making a payment at the cashier through the payer's smart mobile device.

FIG. 5 is a flowchart illustrating, according to one embodiment of this invention, a stage of executing the payment transaction for making a payment at the cashier through the payer's smart mobile device.

FIG. 6 depicts, according to one embodiment of this invention, screen-displayed views seen by the user in the making of a payment at the cashier through the payer's smart mobile device.

FIG. 7 is a flowchart illustrating, in accordance with one embodiment of this invention, a stage of confirmation at the cashier for making a payment at the cashier through the payer's RFID card.

FIG. 8 is a flowchart illustrating, in accordance with one embodiment of this invention, a stage of executing the payment transaction for making a payment at the cashier through the payer's RFID card.

FIG. 9 depicts, in accordance with one embodiment of this invention, screen-displayed views seen by the user in the making of a payment at the cashier through the payer's RFID card.

FIG. 10 is a flowchart illustrating, according to one embodiment of this invention, a stage of identity confirmation when making on-line payment or payment via a phone by means of the payer's smart mobile device.

FIG. 11 is a flowchart illustrating, according to one embodiment of this invention, a stage of executing the payment transaction when making on-line payment or payment via a phone by means of the payer's smart mobile device.

FIG. 12 depicts, according to one embodiment of this invention, screen-displayed views seen by the user in the making of on-line payment or payment via a phone by means of the payer's smart mobile device.

FIG. 13 depicts, in accordance with one embodiment of this invention, a posture of a user when entering an unlocking pattern by eye positioning.

FIG. 14 depicts, in accordance with one embodiment of this invention, a process of a user entering an unlocking pattern by right eye positioning.

FIG. 15 depicts, in accordance with one embodiment of this invention, a process of a user entering an unlocking pattern by left eye positioning.

### DETAILED DESCRIPTION OF THE INVENTION

The present invention is illustrated by the embodiments disclosed hereinafter together with the figures.

This invention discloses an electronic-payment authentication process with an eye-positioning method for unlocking a pattern lock. The invention works by introducing an integrated third-party payment system (shall be referred to as “the System”) in an ordinary payment service. For a payer, the role of the System is to provide a personal, integrated electronic-payment account linked to personal credit cards, debit cards, club membership cards and shop coupons. When making a payment at a physical retail site or through a phone call or on the Internet, the payer can access credit cards, debit cards, club membership cards and shop coupons through the account, where such various cards and coupons are already registered with the System. Payment is transferred from a financial account selected by the payer to a bank account of the System, and is then transferred to the merchant's bank account from the bank account of the System.

To the bank that serves the payer, the System is the recipient of the payment. After the payer confirms the payment transaction via the System, the transaction instruction and the authorization will be sent to the bank from the System. The transaction is processed by the bank according to the standard credit card payment procedure or the standard debit card payment procedure. After this transaction is complete, the bank will confirm to the System the amount of fund that will be received, and will arrange transfer of the fund.

To the merchant, the role of the System is similar to a bank that supports fund-receiving service. The System provides to the merchant a platform and equipment for receiving payments by means of personal credit cards, debit cards, club membership cards and shop coupons.

In the embodiments: the payer's identity and validity of the associated payments are confirmed by the System verifying the registration of payer's electronic-payment user device; the payer's identity is further confirmed by the payer unlocking a pattern lock; the payer is taken a photo of his or her facial appearance and the photo is sent to and stored in the System; and a merchant compares the payer's actual facial appearance with the payer's recent photos as recorded in the System, in order to further confirm the payer's identity.

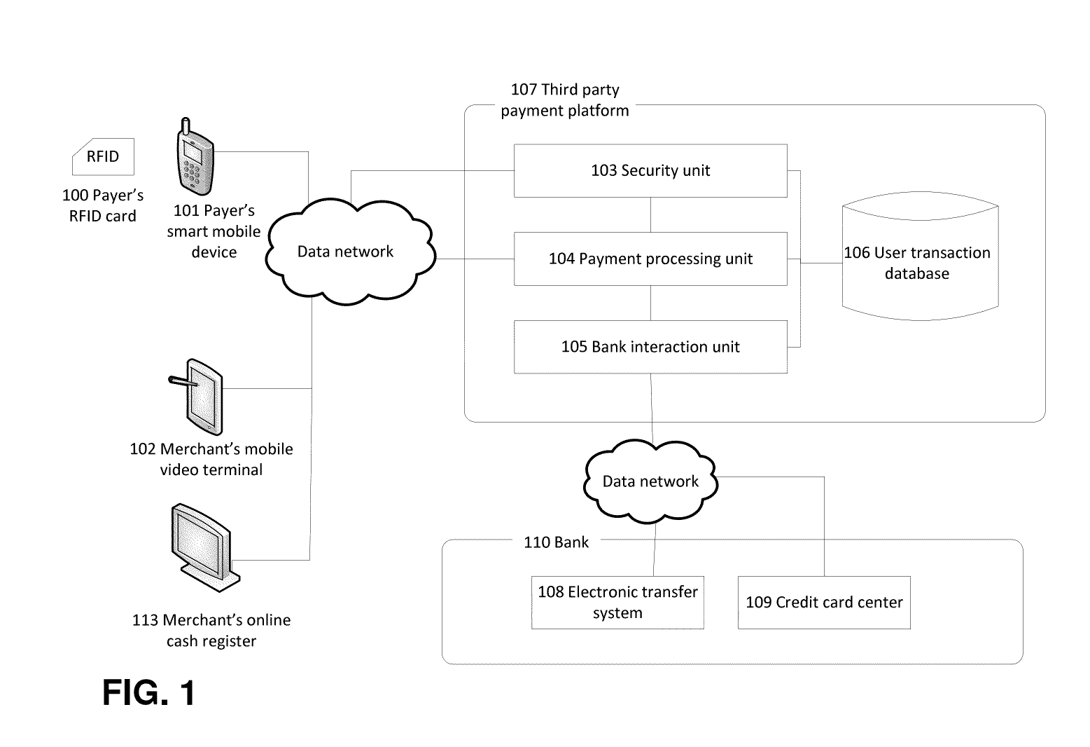

FIG. 1 depicts a schematic diagram of an anti-theft mobile e-payment system in accordance with one embodiment of the present invention. As shown in FIG. 1, the System includes: the payer's RFID card 100 or the payer's smart mobile device 101, either of them being connected to the third-party payment platform 107 and the merchant's mobile video terminal 102; and the merchant's online cash register 113. The third-party payment platform 107 includes a security unit 103, a payment processing unit 104, a bank interaction unit 105 and a user transaction database 106. The third-party payment platform 107 connects to either an electronic transfer system 108 or a credit card center 109 of a bank 110 through a data network.

The payer's smart mobile device 101 and the merchant's mobile video terminal 102 have almost the same hardware requirements. The same hardware requirements include at least a 3.7-inch color monitor, connection to the Internet via the Wi-Fi technology or the third-generation (3G) mobile wireless technology or via other high-speed wireless networks, a front-end camera with at least 300,000 pixels, and a memory space of at least 100 MB. An additional hardware requirement for the merchant's mobile video terminal 102 is an RFID (Radio Frequency Identification) card reader. Operating systems of the payer's smart mobile device 101 and the merchant's mobile video terminal 102 may be Android, iOS, Windows, BlackBerry OS, Bada, or any other operating system that supports loading and running third-party applications. The most important difference between the payer's smart mobile device 101 and the merchant's mobile video terminal 102 is the installed payment system application.

At the time of payment, the payer-identity authentication that the payer shall provide can be transmitted to the third-party payment platform 107 through an electronic code provided by an electronic-payment user device. The electronic-payment user device can be: a smart mobile device 101 used, such as a smart phone or a tablet computer, for making payment at a retail site or through a telephone call or via the Internet; or an RFID card 100 used for making payment at a physical retail site. The electronic code outputted by the smart mobile device 101 is called the Payment Approval Code; and the electronic code outputted by the RFID card 100 is called the RFID Card Number. The payer's smart mobile device 101 is installed with a personal payment program which provides many functions, such as generation of the Payment Approval Code, input of a payment-related unlocking pattern to unlock a pattern lock, video-taking payer's facial appearance, system communications, updating details of an account, review and management of personal payment transactions. The merchant's mobile video terminal 102 is installed with a merchant payment-receiving program, which provides many functions, such as receiving the Payment Approval Code and the RFID Card Number, input of a payment-related unlocking pattern for unlocking a pattern lock, video-taking payer's facial appearance, system communications, updating details of an account, marketing and business promotion, review and management of the merchant's payment-receiving transactions. The merchant's online cash register 113 for receiving funds via phone calls or by the Internet also provides a function of the same payment-related unlocking pattern input, and system communication functions. All data exchange related to system accounts and payment transactions is done over an encrypted network connection to the third-party payment platform 107.

On the third-party payment platform 107, the security unit 103 interacts with the payer and the merchant-side system. Its main functions include: encryption of network connections, system account creation, account login information verification, payment-related unlocking pattern verification, verification of the RFID Card Number, verification of the payer's smart mobile device and the merchant's mobile video terminal, control of the Payment Approval Code generation, and verification of the Payment Approval Code. After all information is verified and confirmed by the security unit 103, the payment transaction will be handed over to the payment processing unit 104 for subsequent operations. The payment processing unit 104 is configured to sequentially issue payment-card debiting requests to the bank interaction unit 105, to issue confirmations of successful payment to the payer and the merchant, to confirm that the payment has been transferred to the system's bank account, and to issue electronic transfer requests for transferring the amount that should be received by the merchant from the system's bank account to the merchant's bank account.

In this process, the payment processing unit 104 is also required to handle all bank transaction exceptions (such as expiry of credit cards, insufficient funds or refusal of credit card authorization), delays of bank deposit or transfer, calculation of a total sum receivable by the merchant, recording and updating financial records of payer accounts and merchant accounts. If the payment involves merchant's special offers or bonus point redemption, the payment processing unit 104 will update the payer's record on special offers and bonus points, and the transaction record between the payer and the merchant.

Apart from processing the merchant's special offers, all credit-card and bank-account related operations are handled by the bank interaction unit 105 and the bank system together. The functions of the bank interaction unit 105 include establishing encrypted network communications with various systems of the bank 110 (including the electronic transfer system 108 and the credit card center 109), processing authorization of operations on the bank accounts of the payer and the merchant, integrating and performing data exchange among various systems of the bank 110, controlling flows of bank transfer instructions and diverting to multiple flows in case of a large number of instructions. The aforesaid three units of the System need read-write access to the user transaction database 106. The user transaction database 106 provides to the security unit 103 all authentication data of the payer's account and the merchant's account. The encryption algorithm for encrypting system user information and the Payment Approval Code must also be stored in the user transaction database 106. The payment processing unit 104 also read-write accesses the user transaction database 106 on data regarding the merchant's special offers, and stores all completed transaction records to the user transaction database 106. The bank interaction unit 105 is required to obtain the corresponding authentication information of the payer's account and the merchant's account from the user transaction database 106.

During the process of payment while the payer is using the electronic-payment user device, it is required to perform a fundamental authentication process in order to make the payment process secure. In the disclosed embodiment, it is required to perform the following authentication process.

First, the merchant's mobile video terminal 102 receives either the RFID Card Number from the payer's RFID card 100 or the Payment Approval Code from the payer's smart mobile device 101. When the IMEI (International Mobile Equipment Identity) of the smart mobile device 101 is confirmed by the security unit 103, the smart mobile device 101 will generate a Payment Approval Code. This Payment Approval Code is a group of encrypted string, which provides confidentiality to the payer's identity, and to the time and date of encryption. The method of encryption and corresponding decryption is regularly changed in order to provide confidentiality to the payer's identity and to ensure that the payment transaction is operated from the payer's smart mobile device 101 already registered by the enrolled person of the account, and not from a thief who impersonates the payer to make the payment. The Payment Approval Code is computed by a regularly-changed asymmetric key pair to encrypt and decrypt a composite data set formed according to the payer's identity, and time and date of encryption, so as to enable the electronic-payment system to approve the payment if: successful decryption is achieved; the payer's identity matches a corresponding record in System; and the time and date of encryption are not expired. The asymmetric key pair for encrypting and decrypting the Payment Approval Code is regularly changed over time. This method can further increase the confidentiality provided to the payer's identity. The registered smart mobile device 101 of the payer regularly receives the most-updated public key to encrypt the payer's identity and the time and date of encryption. Furthermore, encryption can be carried out only if the payer's identity is consistent with the registered user of the smart mobile device 101. If the merchant's mobile video terminal 102 or the payer's smart mobile device 101 has not carried out encryption key update after a given time, the user can no longer proceed with the payment via the System until such equipment is re-connected with the security unit 103 and performs an update.

Data transfer during the whole payment process shall use an encrypted network-transmission protocol for confidential transmission. The data after encryption is transmitted via the merchant's mobile video terminal 102 to the security unit 103 of the third-party platform 107 for verification. In the verification process, the security unit 103 uses a private key to decrypt and obtain the payer's identity and the time and date of encryption. That the payer's identity is the same as the one recorded in the System and that the time and date of encryption does not exceed the security time limit both must be satisfied for allowing the payer to proceed with the payment.

For a payer who does not have a smart mobile device, the payer's RFID card 100 possessed by this payer has a built-in RFID Card Number. This number represents the payer's identity and a serial number. Regardless of whether the payment transaction is completed or not, every time when the payer's RFID card 100 senses the merchant's mobile video terminal 102, copies of the serial number in the payer's RFID card 100 and in the user transaction database 106 of the third-party payment platform 107 will be updated. When the transaction is being carried out, the security unit 103 of the third-party payment platform 107 will verify the payer's identity of the RFID card 100 and determine if the most-recent serial number of this RFID card exceeds a certain pre-defined number when compared to the serial number stored in the last record of the user transaction database 106. The payer can proceed with the payment only if the result of this determination is positive.

Apart from presenting a Payment Approval Code or a RFID Card Number, the payer is further required to input an unlocking pattern on a pattern diagram associated with a pattern lock. This pattern diagram is pre-stored in the user transaction database 106, and is transmitted via a communication network to the smart mobile device 101 or the merchant's mobile video terminal 102 for display. The payment-related unlocking pattern is the path generated on the pattern diagram (shown on a display) according to the movement of the eyeball image or the movement of a finger, when a digital camera installed in the smart mobile device 101 or the merchant's mobile video display 102 is performing video-taking. The pattern diagram comprises a plurality of rings. The path appears to be formed by hopping among the plurality of rings, hopping on any one of the rings with more than one time being allowable.

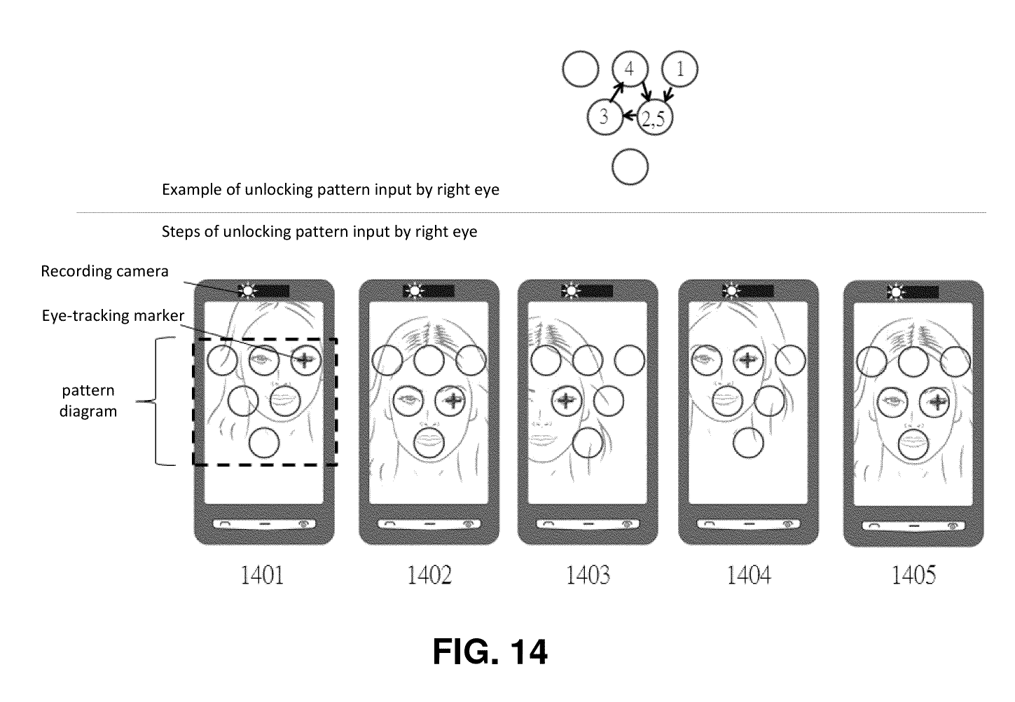

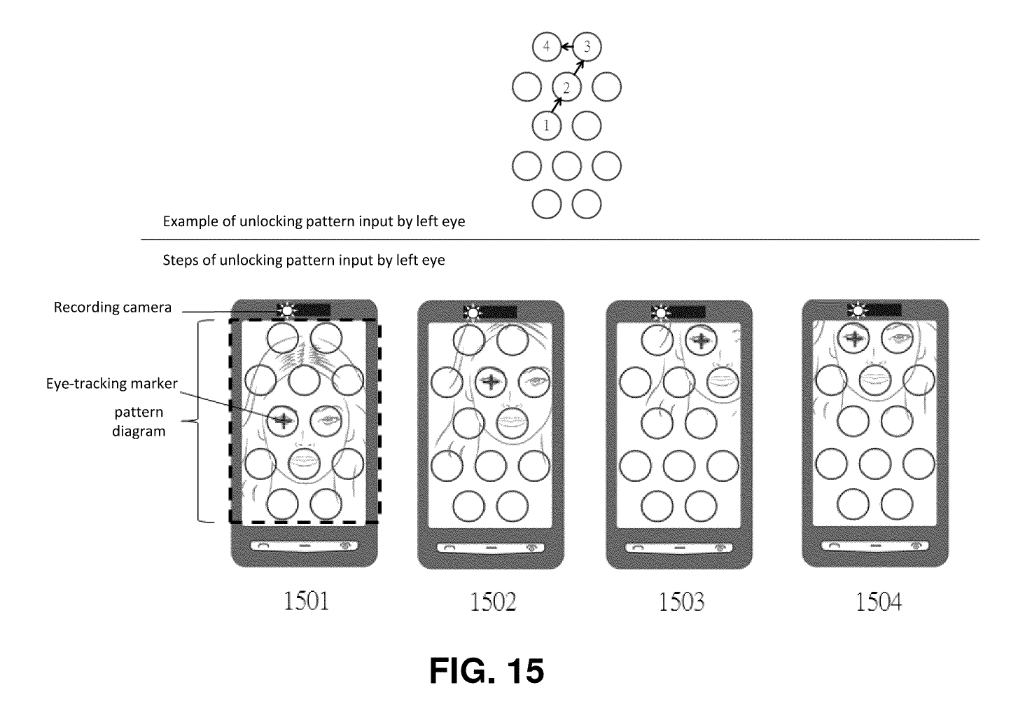

The pattern diagram is a mono-colored diagram formed by the plurality of rings, wherein the user determines the number of the rings and the position of the rings to form the pattern diagram. The intention of such user-defined diagram is to provide flexibility to the user on the complexity of the pattern diagram, in order to adapt to the needs of different users. For example, elderly people tend to prefer pattern diagrams that are simple and easy to remember, and they may select pattern diagrams with fewer rings as is shown in FIG. 14. In another example, high-spending customers tend to prefer complex pattern diagrams to enhance security, and they may select pattern diagrams with more rings as is shown in FIG. 15. No matter which pattern diagram is used, account security can be enhanced by user regularly changing the pattern diagram and the unlocking pattern.

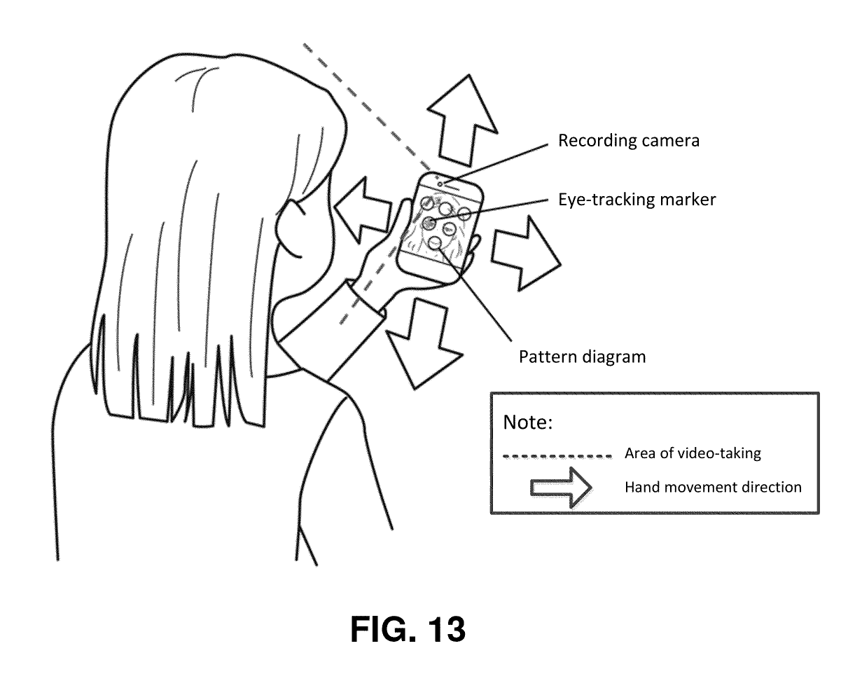

When entering the unlocking pattern, if the electronic-payment user device in the embodiment is the RFID card 100, the merchant's mobile video terminal 102 shall be used for video-taking. If the electronic-payment user device in the embodiment is not the RFID card 100, the smart mobile device 101 shall be used for video-taking. The smart mobile device 101 or the merchant's mobile video terminal 102 captures the payer's facial appearance and real-time display the facial image that is captured. At the same time, an eye of the payer is real-time tracked by an object-recognition software to enable a marker to locate the eye, wherein the eye is either a left eye or a right eye as pre-agreed or pre-set by the payer. The payer can control a path generated by the movement of the marker by the eye. During entering the unlocking pattern, controlling the marker is determined according to movement of the eye relative to the video-taking equipment. One common method used by the payer is to keep the head stationary when facing the camera, and to move the smart mobile device 101 or the merchant's mobile video terminal 102 by the payer's hand in order to track the marker's movement on the pattern diagram for entering the unlocking pattern, as is illustrated in FIGS. 13-15. On the same pattern diagram, the payer may alternatively use a finger tip instead of the eye to control the marker-movement path for linking one of the rings with another one sequentially, allowing the electronic-payment system to compare the marker-movement path with the pre-set, correct action path to perform the same security verification and recording. After the unlocking pattern is verified to be correct, the payment can continue to proceed.

Specifically, an eye-positioning method, disclosed in the present invention, for unlocking a pattern by a user comprises the following steps.
Show to the user a pattern diagram on a display, the pattern diagram being pre-stored in a storage device at a back-end server. That is, the pattern diagram stored in the user transaction database 106 is transmitted via a network to the display, so that the pattern display can be displayed to the payer only on the smart mobile device 101 or the merchant's mobile video terminal 102.
Capture live facial image of the user by a video-taking equipment coupled to the display. An eye of the user based on the facial image is real-time tracked, enabling a marker to track the eye, wherein the eye is either a left eye or a right eye as pre-agreed.
Enable the marker to move on the pattern diagram to form a marker-movement path according to movement of the eye relative to the video-taking equipment.
Determine if the marker-movement path includes an entirety of a pre-set action path. If a positive result is obtained, the pattern lock is unlocked so that the next step in the process of making the payment can be initiated.

The pattern diagram comprises a plurality of rings, and is formed by hopping among the rings, where hopping on any one of the rings with more than one time is allowable.

After the user's facial appearance is captured by the video-taking equipment, e.g., a camera attached to a smart phone, an eye-tracking control module is employed for object recognition so as to recognize an eye region from the captured facial image. The eye-tracking control module is coupled to the video-taking equipment. The eye-tracking control module is configured to detect the eye's position by an object-recognition algorithm according to the payer's facial appearance obtained by the video-taking equipment such that the marker's position is determined by the eye's position. Specifically, the video-taking equipment first sends the captured facial image to the display. At the same time, a detection module of the eye-tracking control detects a region of a face from the facial image. The eye region is then identified within the face region by comparison and matching. This comparison and matching may be done by, for example, contour matching, iris/pupil identification, grayscale method, etc. The position that is determined for the left eye and/or right eye is used by the marker for real-time tracking. The position of the marker shown on the display and the position of the eyeball are consistent.

After the real-time captured face region and the pattern diagram appear on the screen, the payer makes use of the left eye or the right eye as pre-agreed to unlock the pattern lock. First, use the eye to move the marker to a pre-determined ring. After the marker enters into a centre of the ring, a processing module of the security unit 103 determines that the marker has moved to a correct position. Afterwards, the payer uses the eye to move the marker to a second pre-determined ring until all the rings on the pre-determined path have been sequentially entered in the right order. Then the process of entering the unlocking pattern is determined to be finished. During the unlocking pattern is entered, if the user blinks, there is no changed made to the marker until the user reopen his or her eye again.

FIG. 13 depicts an example of a user using the eye-positioning method to enter an unlocking pattern. A video-taking equipment captures the facial image of the payer. A marker, as an indicator in tracking the eyeball, shows the eye's position. When the eye-positioning method is used to enter the unlocking pattern, the head and the eye may face the camera and remain stationary. Then a hand is used to move the video-taking equipment. The area of video-taking and the movement direction of the hand are as indicated by the dashed lines and the arrows in FIG. 13, so as to enable the marker that is real-time tracking the eyeball image on the screen to correctly draw the unlocking pattern.

FIG. 14 is an example showing the steps of using a right eye to enter an unlocking pattern. FIG. 15 is a corresponding example illustrating the steps of using a left eye for entering the unlocking pattern. As indicated by FIG. 14, a pattern diagram in this example has six rings. The order of hopping on the rings for correctly entering the unlocking pattern pre-set by the payer is as shown by the arrows in the upper half of FIG. 14, viz.
1→2→3→4→5
   Hence, the payer first uses his or her right eye to control the marker to move into the ring that is labeled as 1 (see 1401). Then uses the right eye to control the marker to move into the ring that is labeled as 2 (see 1402). This input procedure is repeated again for other digits to be entered as the unlocking pattern: use the right eye to control the marker to travel into the rings labeled as 3, 4 and 5 (see 1403, 1404 and 1405).

As indicated by FIG. 15, a pattern diagram in this example has 12 rings. The order of hopping on the rings for correctly entering the unlocking pattern pre-set by the payer is as shown by the arrows in the upper half of FIG. 15, viz.
1→2→3→4
   Hence, the payer first uses his or her left eye to control the marker to move into the ring that is labeled as 1 (see 1501). Then uses the left eye to control the marker to move into the ring that is labeled as 2 (see 1502). This input procedure is repeated again for other digits to be entered as the unlocking pattern: use the left eye to control the marker to travel into the rings labeled as 3 and 4 (see 1503 and 1504).

In pattern lock unlocking (as in the embodiment of using the RFID card for payment at a cashier or for online payment) and in confirming the transaction (as in the embodiment of using the smart mobile device 101 for payment at a cashier), the facial appearance of the payer is also captured as a photo for recording. The captured facial appearance of the payer and the data of the transaction are stored in the user transaction database 106. Through the payment system, the payer will then be able to check the recorded facial appearance in every payment record in the past in order to check if the payment account has been fraudulently used.

In addition, the system is designed and equipped with a non-computer-executed security measure. The facial appearance record newly added to the user transaction database 106 will also be used as a reference by a merchant in a next payment. Prior to executing a payment transaction, the merchant's mobile video terminal 102 will show the recent facial photo records for the merchant to compare with the actual facial appearance of the payer in situ. The recent facial photo records are the one or more past photos recorded by the System when the payer made one or more previous payments. If it is apparent that the facial photo records do not match the payer's actual facial appearance, the merchant can terminate the transaction and call the police. If the merchant concludes that the facial photo records are consistent with the payer's actual facial appearance, the payer can be deemed to pass all the security measures and can execute the transaction.

Under this security design, if a thief has stolen the smart mobile device 101 of the user or the RFID card 100, the thief is still lacking of an unlocking pattern and a facial appearance similar to the payer's for payment making.

If the thief uses malicious software to steal the Payment Approval Code, the payer's photo and the unlocking pattern from the merchant's mobile video terminal 102, and to manipulate the merchant's mobile video terminal 102 to imitate a payment, this imitation will fail because the Payment Approval Code will be rejected by the payment system as it was already used in a previous successful transaction.

If the thief camouflages the RFID card 100 of the user, not only is he or she lacking of a facial appearance similar to the payer's but also there is another security measure as follows. When the thief uses a camouflaged RFID card and the original user uses the RFID card 100 again having the two cards sensed by the merchant's mobile video terminal 102 at different time, the security unit 103 will suspend both cards due to incorrect serial numbers therein, in order to prevent further possibility of theft.

Even in the worst-case scenario that the aforementioned security measures are not effective and the thief has successfully made one illegal transaction, the victim user will receive a notification of payment from the system. The payment record can provide this thief's photo taken during the transaction as well as the time, date and place of the payment, and the amount involved. The victim user can immediately report to the system's operating company in order to suspend the stolen account and proceed to recover losses.

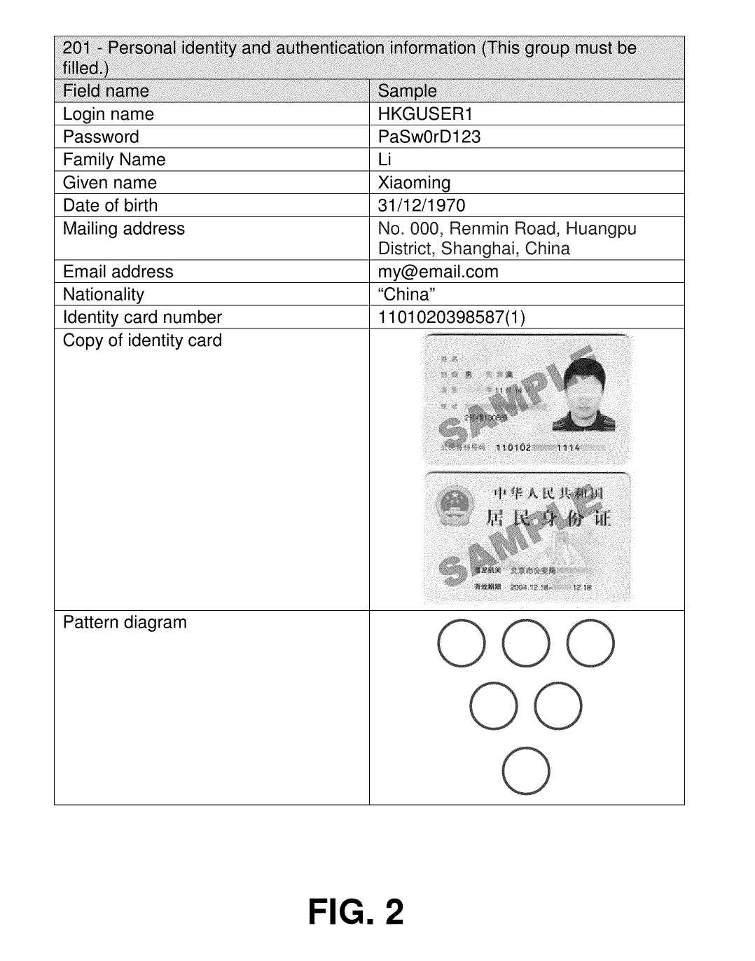

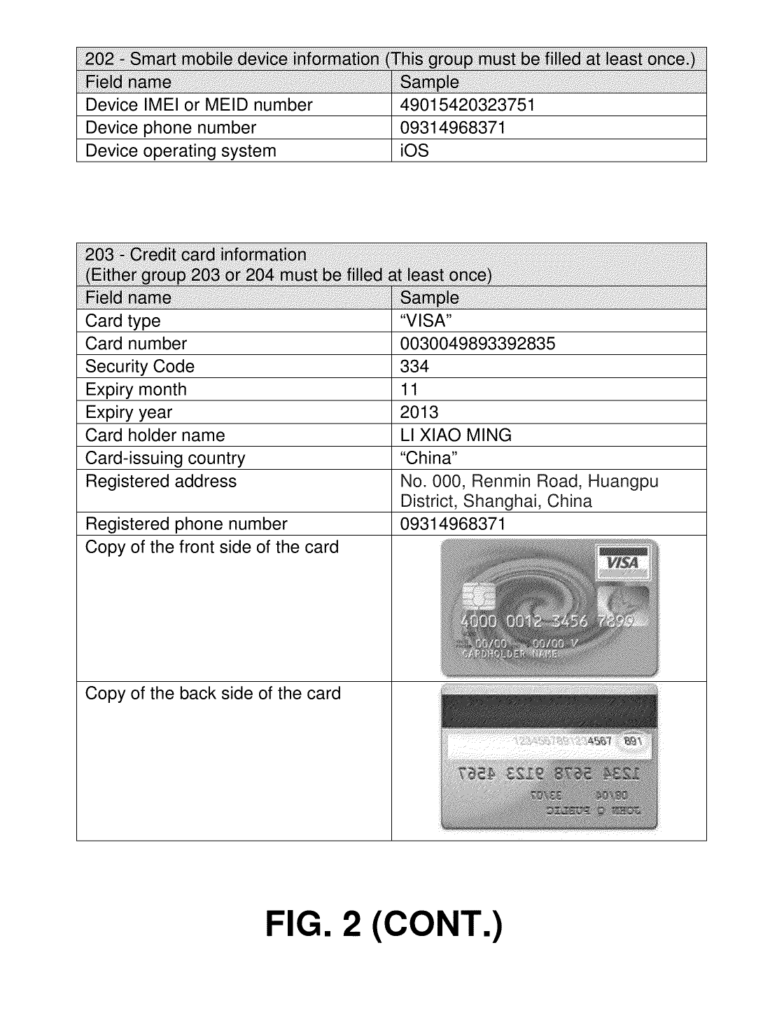

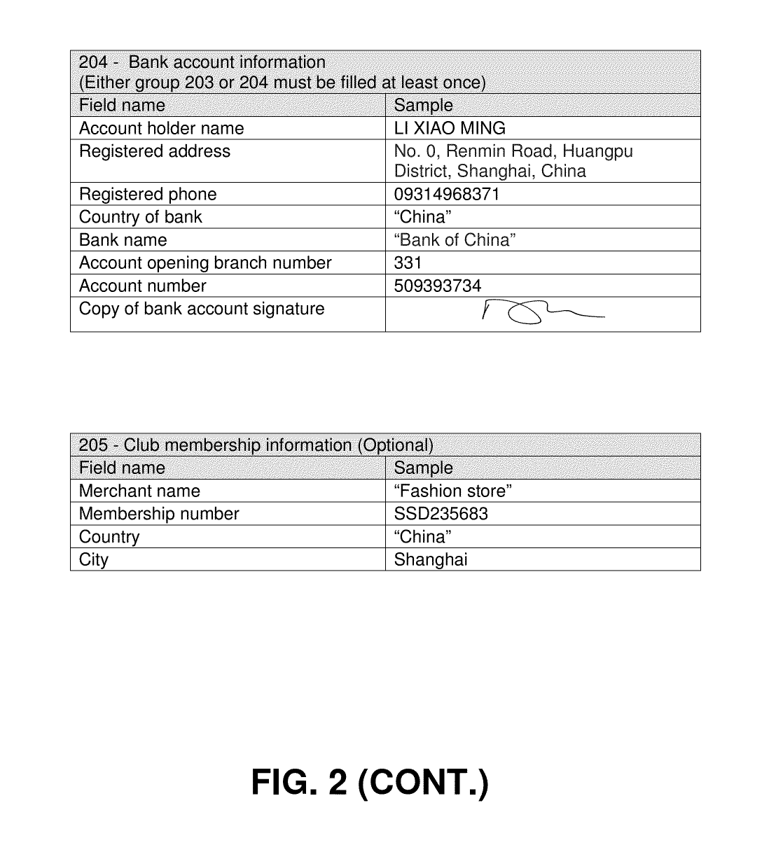

The electronic-payment method disclosed herein requires the payer to open an account in the System. When opening the account, the payer needs to provide groups of information. As indicated in FIG. 2, the groups of information include, for example, his or her personal identity and authentication details 201, the smart mobile device's details 202, the credit card's details 203, bank-account details 204, and information 205 regarding relevant merchant memberships. Upon approval of account opening, the payer can install at the registered payer's smart mobile device 101 a payment application program provided by the system for the payment purpose. If the payer does not have a smart mobile device, he or she may apply for an RFID card 100, which can be used as an electronic payment device.

For a merchant accepting this payment method, the merchant needs to open a merchant account in the System and provide the merchant business information and bank-account information for receipt of payments. Upon approval of account opening, the merchant will obtain the merchant's mobile video terminal 102 for receipt of on-site payments and the system integration component API (Application Programming Interface) for receipt of online or telephone payments. After the merchant opens the account at the System, the merchant will obtain the merchant's mobile video terminal 102 installed at every cashier. If the merchant operates online business, such as online shopping or shopping by phone calls, the System also provides an API to assist the merchant to integrate the System with merchant's computer system, becoming the merchant's online cash register 113. The System also provides transaction-records management and clearing services. When the payment sum is remitted from the payer's debiting bank to the bank account of the System, the System will remit the sum to the merchant's bank account.

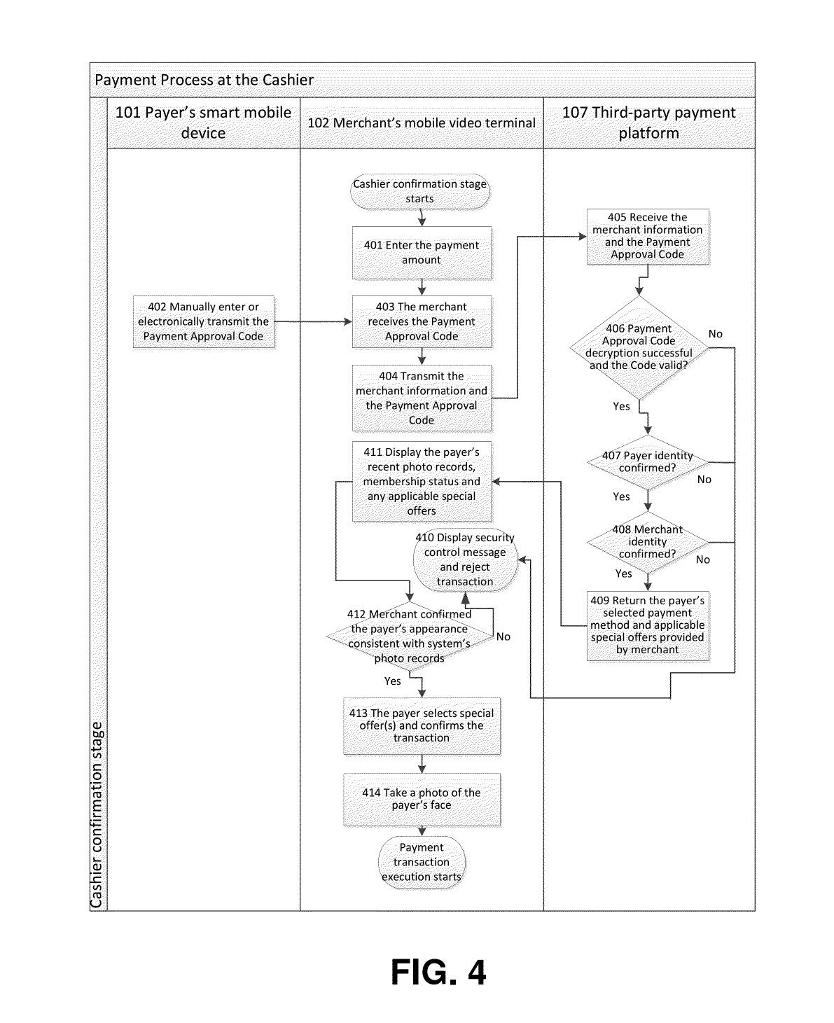

For an on-site payment, the merchant only needs to obtain at the merchant's mobile video terminal 102 the Payment Approval Code provided by the payer or the RFID card 100. After confirmation by unlocking a pattern lock, the recent records of the payer's photo are displayed on the display. After the merchant check and confirm that the photos and the payer's actual facial appearance are consistent, the payer can input at the terminal 102 the remaining payment details. After confirmed by the System, the System debits the payer's payment card and transfers the payment sum to the system's bank account, and then remits the sum to the merchant's payment-receipt account that is registered. For details, please refer to FIGS. 4-5 and FIGS. 7-8 for illustration.

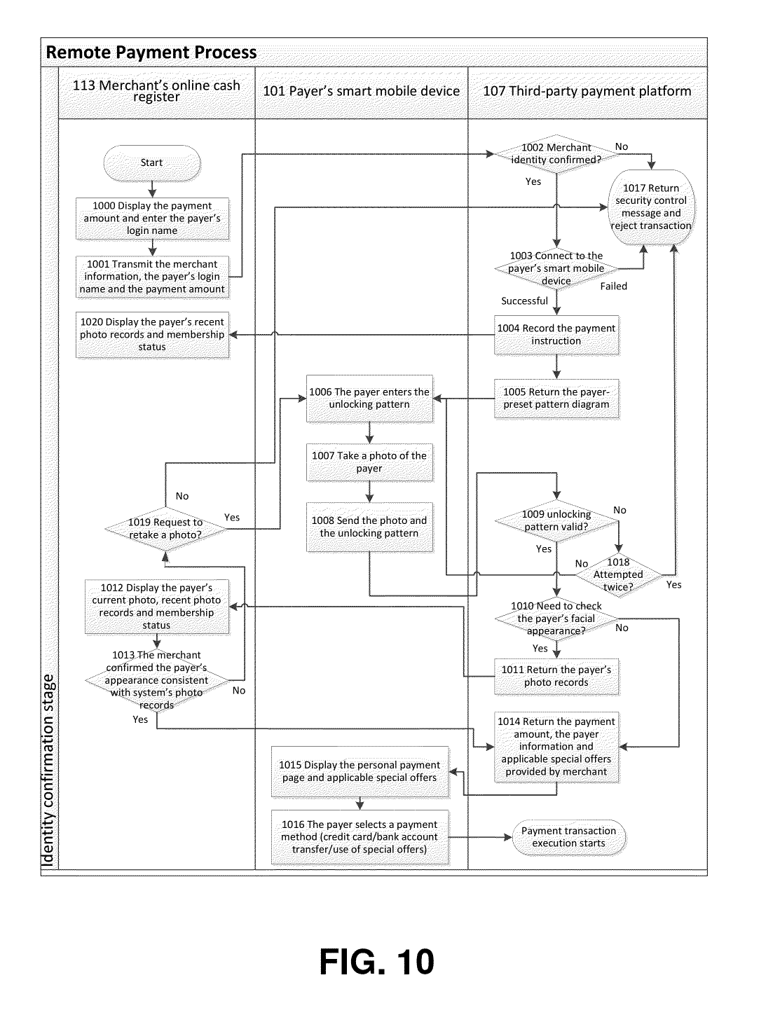

For an online payment or a payment through a phone call, the merchant, via the merchant's online cash register 113, can select whether or not to receive the payment only after manually checking the payer's facial appearance. This step of manual checking is performed by the merchant comparing the current photo returned by the payer and the recent records of the payer's photos in the System. If there is suspicion after comparison, the merchant can refuse the transaction as a security breach. For details, please refer to FIG. 10 for illustration.

After transactions are made, the merchant can at any time log into the payment system to check previous payment records.

Apart from receiving payments, the merchant can also perform marketing and business promotion activities via the System disclosed in the present invention. Viable business promotion schemes include sending e-coupons to users of the system where the users satisfy some requirements. All e-couples issued to the users are recorded in the user transaction database 106. After the merchant issues e-couples to the users who satisfy the requirements, these users will receive notifications from the system. Each of these users will be able to enjoy a concessionary price by checking a box of using an e-coupon on the payment confirmation screen when making a payment at the merchant. Please see FIGS. 4, 7 and 10 for the process flow diagram.

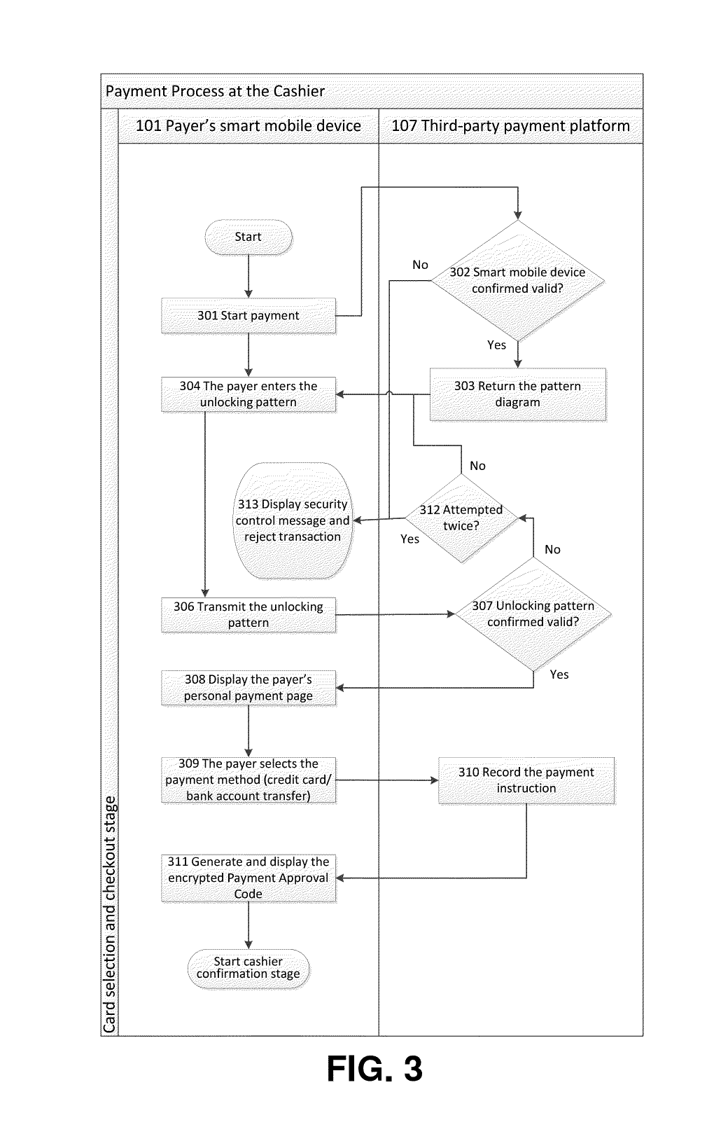

In an embodiment regarding payment at a physical retail site, the payer only needs to use the payment application program installed at the payer's smart mobile device 101 to confirm using which registered payment method and to input an unlocking pattern. The program generates a Payment Approval Code, which is thereafter received by the merchant's mobile video terminal 102 of the cashier. Then the payer's photos in record are checked with the actual facial appearance. Finally, the payer is allowed to select whether or not to use an e-coupon and a payment card. Meanwhile, the facial appearance of the payer is photographed as part of the transaction record. After the payer confirms the payment, the payer's smart mobile device 101 that has been registered and the merchant's mobile video terminal 102 will receive notifications of payment confirmation. For details, please refer to FIGS. 3-5 for the process flow diagram.

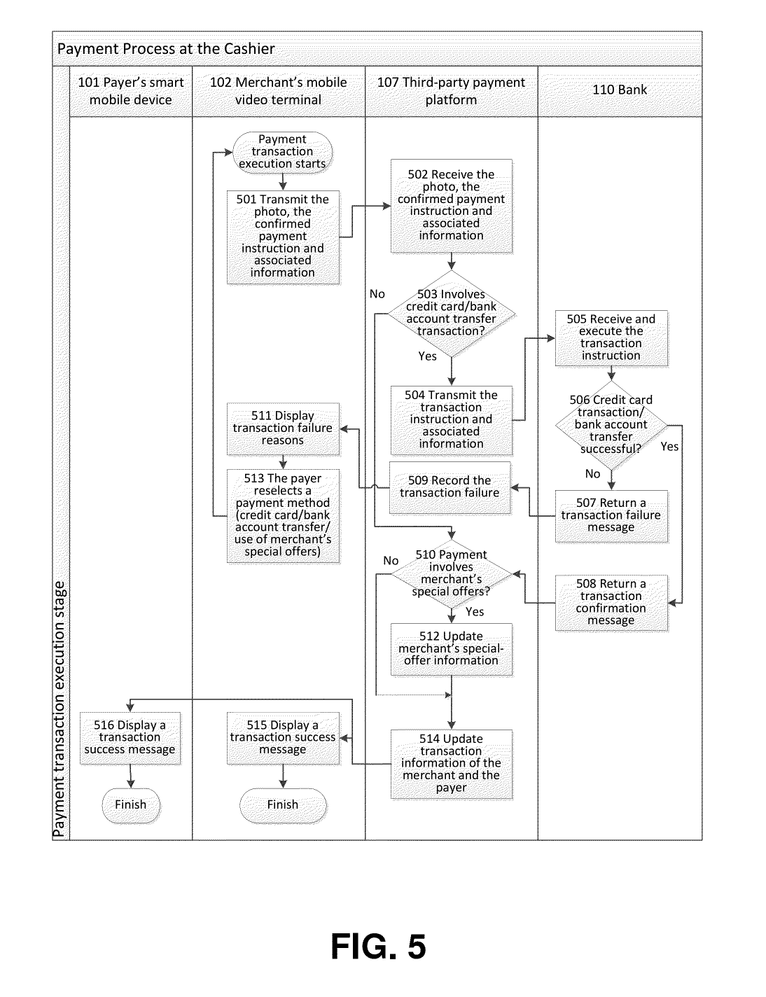

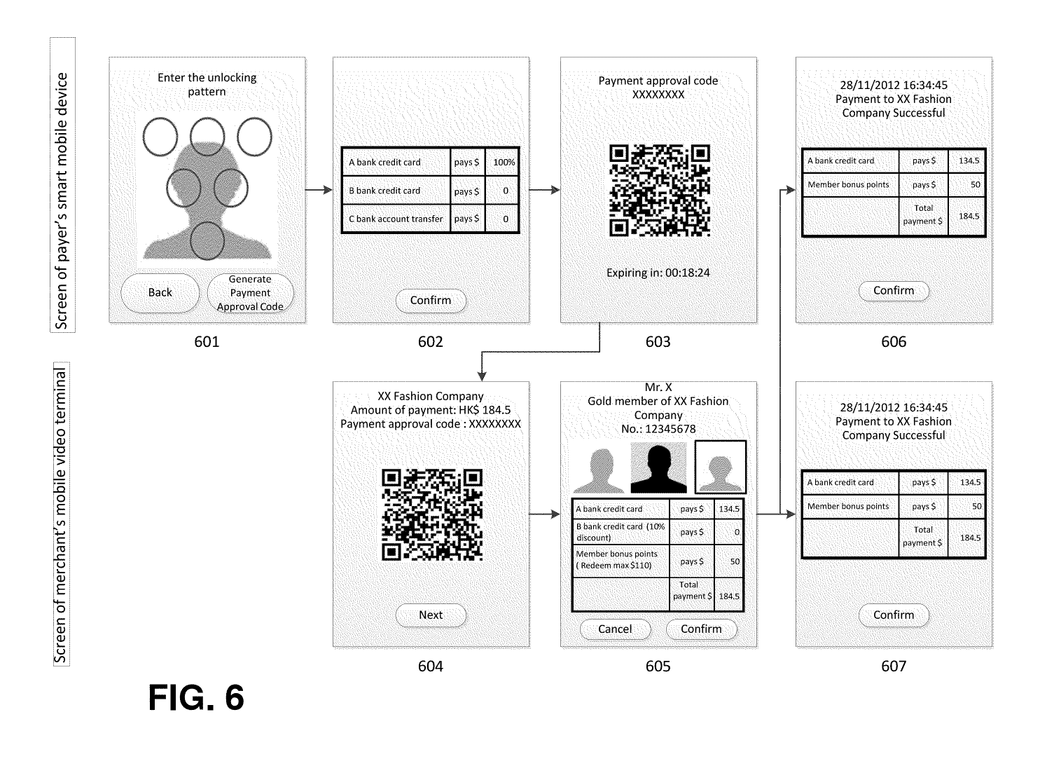

There are three stages in the process of making payment at the cashier through the payer's smart mobile device 101: the card selection and checkout stage (FIG. 3); the cashier confirmation stage (FIG. 4); and the payment transaction execution stage (FIG. 5). In these three stages, the sequence of screen-displayed views seen by the user is shown in FIG. 6.

The card selection and checkout stage and making the payment at the cashier through the payer's smart mobile device 101 (FIG. 3) comprises the following process.
301—Start the payment program and connect to the third-party payment platform 107.
302—The third-party payment platform 107 determines whether the connected smart mobile device 101 has been validly registered in the system.
303—If the result of the step 302 is “No”, the system displays the security control message and details on the payer's smart mobile device 101 and refuses the transaction. Otherwise, the system returns a pattern diagram to the payer's smart mobile device 101.
304—The payer enters an unlocking pattern by moving the eye-tracking marker, or touching and drawing by a finger.
306—The system transmits the unlocking pattern to the security unit 103 of the third-party payment platform 107.
307—The system checks whether the unlocking pattern is consistent with the system record.
312—If the result of 307 is “No”, the system proceeds to a subsequent step checking the number of wrong unlocking patterns attempts. If the number of attempts reaches three, the transaction is rejected; otherwise, the system requires the payer to re-enter an unlocking pattern in the step 304.
308—If the result of the step 307 is “Yes”, the system displays the payer's personal payment page on the payer's smart mobile device 101.
309—The payer selects the payment method on the personal payment page. The selectable payment methods include credit-card payment and bank account transfer.
310—The system records the preliminary payment instruction in the user transaction database 106.
311—The system generates an encrypted Payment Approval Code on the payer's smart mobile device 101 and displays it on the screen. The cashier confirmation stage starts from this point.

The cashier confirmation stage for making a payment at the cashier through the payer's smart mobile device 101 (FIG. 4) comprises the following process.
401—The merchant enters the amount to be received on the merchant's mobile video terminal 102.
402—The payer manually enters or electronically transmits the displayed Payment Approval Code generated in the step 311 to the merchant's mobile video terminal 102.
403—The merchant receives the Payment Approval Code through the merchant's mobile video terminal 102. The Payment Approval Code can be manually entered through a keyboard or automatically transmitted to the merchant's mobile video terminal 102 at the cashier through technologies such as Matrix Barcode or Near Field Communication.
404—The merchant's mobile video terminal 102 automatically transmits the merchant information and the received Payment Approval Code to the security unit 103.
405—The security unit 103 of the third-party payment platform 107 automatically receives the merchant information and the Payment Approval Code.
406—The security unit 103 successfully decrypts the Payment Approval Code, checks the time and date of encryption, and confirms the validity of the Payment Approval Code.
407—If the result of the step 406 is “Yes”, the system checks the payer's identity in the Payment Approval Code against the payer record(s) in the user transaction database 106 for payer authentication.
408—If the result of the step 407 is “Yes”, the system checks the received merchant information against the record(s) in the user transaction database 106 for merchant authentication.
409—If the result of the step 408 is “Yes”, the system returns a record of the payment method selected earlier by the payer and applicable special offer(s) provided by the merchant for the transaction.
411—The system displays recent records of the payer's photos, any membership status and applicable special offer(s) on the merchant's mobile video terminal 102.
412—The merchant determines, by naked eyes, if the payer's actual facial appearance is similar to the records of the payer's recent photos shown on the merchant's mobile video terminal 102.
410—If the result of any of the steps 406, 407, 408 and 412 is “No”, the system displays the security-compromise message on the merchant's mobile video terminal 102 according to the reason of failure, and refuses the transaction.
413—If the result of the step 412 is “Yes”, the merchant allows the payer to select special offer(s) on the merchant's mobile video terminal 102, and confirm the transaction.
414—At the instance that the transaction is confirmed, the merchant's mobile video terminal 102 takes a photo of the payer's facial appearance.

The payment transaction execution stage for making a payment at the cashier through the payer's smart mobile device 101 (FIG. 5) comprises the following process.
501—The merchant's mobile video terminal 102 transmits a photo of the payer, the confirmed payment instruction and associated information to the third-party payment platform 107.
502—The security unit 103 of the third-party payment platform 107 automatically receives the photo of the payer, the payment information and the instruction.
503—The system checks whether the payment instruction involves a credit-card payment or a bank-account transfer transaction.
504—If the result of the step 503 is “Yes”, the system transmits the payment instruction and associated information to the relevant bank for processing.
505—The bank automatically receives the payment instruction and associated information. If the result of the step 503 is “No”, the system checks whether the payment information involves the use of special offer(s) provided by the merchant indicated as step 510.
506—According to the bank's procedures for internal processing of credit-card or bank-account transfer transactions, the bank determines whether the transaction is successful.
507—If the result of the step 506 is “No”, the system sends a transaction failure message to the third-party payment platform 107.
508—If the result of the step 506 is “Yes”, the system sends a transaction confirmation message to the third party payment platform 107.
509—The third-party payment platform 107 records the transaction failure in the user transaction database 106.
510—The system checks whether the payment information involves the use of special offer(s) provided by the merchant.
511—The system displays reason(s) of transaction failure on the merchant's mobile video terminal 102.
512—If the result of the step 510 is “Yes”, the system updates the merchant special-offer information in the user transaction database 106.
513—The payer reselects a payment method on the merchant's mobile video terminal 102.
514—The system updates transaction information of the merchant and the payer in the user transaction database 106.
515—Transaction success message is displayed on the merchant's mobile video terminal 102.
516—Transaction success message is displayed on payer's smart mobile device 101.

The screen-displayed views seen by the user in the making of a payment at the cashier through the payer's smart mobile device 101 (FIG. 6) comprises the following views.
601—When the step 304 starts, the payer's smart mobile device 101 displays a view of a pattern diagram for input.
602—When the step 308 starts, the payer's smart mobile device 101 displays the payer's personal payment page for payment-method selection.
603—When the step 311 starts, the payer's smart mobile device 101 displays a screen of Payment Approval Code.
604—When the step 403 starts, the merchant's mobile video terminal 102 displays a view of the merchant's receipt of the Payment Approval Code.
605—When the step 411 starts, the merchant's mobile video terminal 102 displays a view of the payer's photos that are recently recorded, the real-time payer's facial image, selection of the merchant's special offer(s) and the transaction confirmation interface.
606—When the step 516 starts, the payer's smart mobile device 101 displays a view of transaction-successful confirmation.
607—When the step 515 starts, the merchant's mobile video terminal 102 displays a view of transaction-successful confirmation.

For a payer without a smart mobile device 101, he or she can apply for an RFID card 100 upon approval of opening an account. When making a payment at a retail site, the payer only needs to present his/her RFID card 100 for non-contact short-distance sensing with the merchant's mobile video terminal 102. Then the cashier asks the payer to enter an unlocking pattern, and compares payer's facial appearance against records of the payer's photo for identity confirmation. A photo of the payer is also taken and is saved as part of the transaction record. Next, the payer can determine which registered payment method to be used and select any applicable special offer(s). Upon payer confirming the payment, the payer's registered mobile phone and the merchant's mobile video terminal 102 will receive payment-successful confirmations.

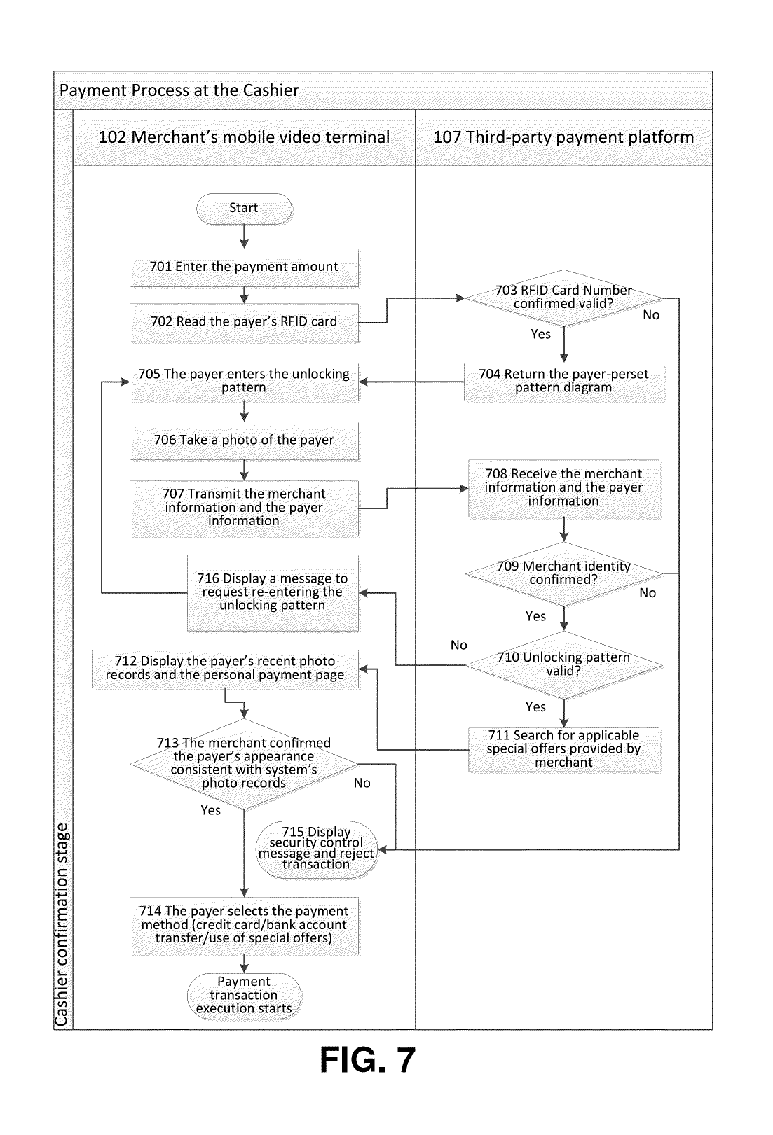

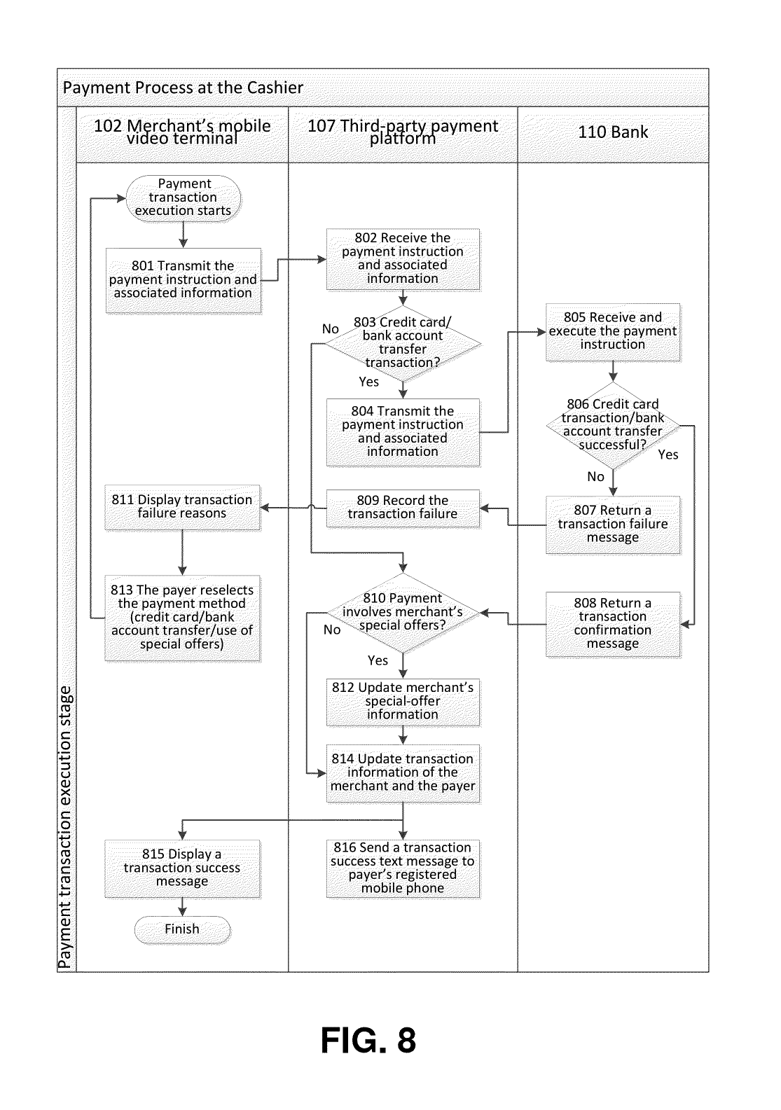

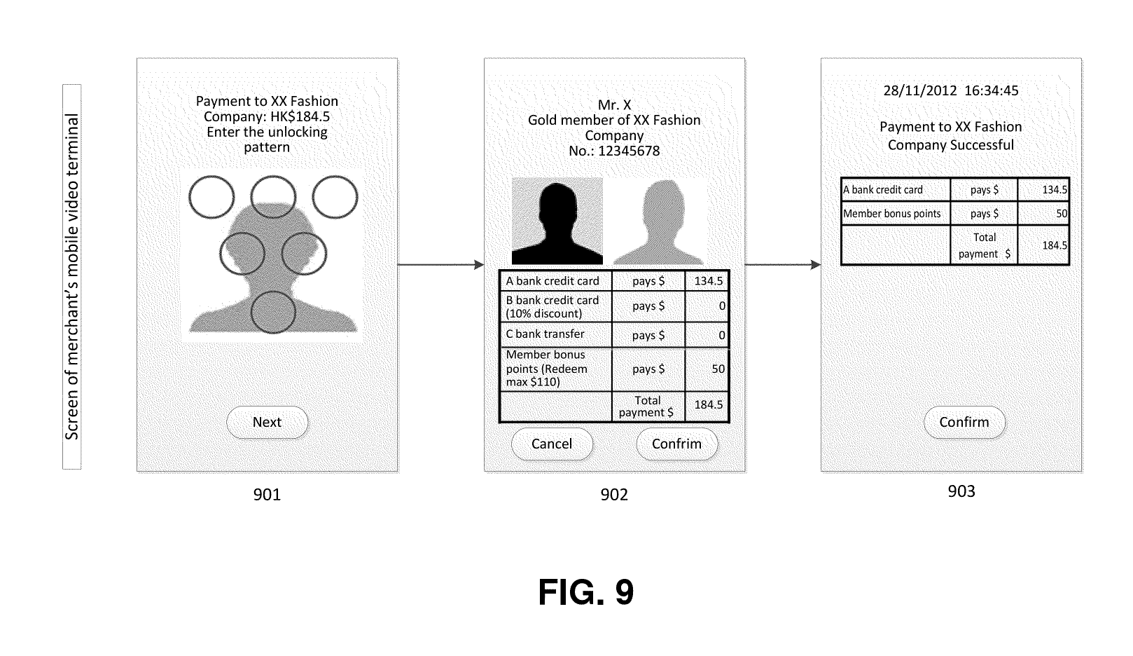

There are two stages in the process of making payment at the cashier through the payer's RFID card 100: the cashier confirmation stage (FIG. 7); and the payment transaction execution stage (as indicated in FIG. 8). In these two stages, the sequence of screen-displayed views seen by the user is shown in FIG. 9.

The cashier confirmation stage for making a payment at the cashier through the payer's RFID card 100 (FIG. 7) comprises the following process.
701—The merchant enters the amount to be received on the merchant's mobile video terminal 102.
702—A reader of the merchant's mobile video terminal 102 reads the payer's RFID card 100 to acquire the RFID Card Number.
703—The RFID Card Number is transmitted to the security unit 103 of the third-party payment platform 107 for identity confirmation.
704—If the result of the step 703 is “Yes”, the system will send a payer-preset pattern diagram from the user transaction database 106 to the merchant's mobile video terminal 102.
705—The payer enters an unlocking pattern on the merchant's mobile video terminal 102 by moving the eye-tracking marker, or touching and drawing by a finger.
706—The merchant's mobile video terminal 102 automatically takes a photo of the payer.
707—The merchant's mobile video terminal 102 automatically transmits the merchant information and the payment information to the security unit 103.
708—The security unit 103 of the third-party payment platform 107 automatically receives the merchant information and the payment information.
709—The payment security unit 103 checks the received merchant information against the record(s) in the user transaction database 106 for merchant authentication.
710—If the result of the step 709 is “Yes”, the system checks the unlocking pattern entered by the payer against the one recorded in the user transaction database 106 for payer authentication.
711—If the result of the step 710 is “Yes”, the system searches for special offer(s) provided by the merchant that is applicable for this transaction.
716—If the result of 710 is “No”, the system will require the payer to re-enter an unlocking pattern as step 705.
712—The system displays recent records of the payer's photo and a personal payment page on the merchant's mobile video terminal 102.
713—The merchant determines, by naked eyes, if the payer's actual facial appearance is similar to the records of the payer's recent photos shown on the merchant's mobile video terminal 102.
714—If the 713 result is “Yes”, the merchant allows the payer to select a payment method and any special offer(s) on the merchant's mobile video terminal 102, and confirm the transaction.
715—If the result of any of the steps 703, 709 or 713 result is “No”, the merchant's mobile video terminal 102 will display the security control message, and reject the transaction.

The payment transaction execution stage for making a payment at the cashier through the payer's RFID card 100 (FIG. 8) comprises the following process.
801—The merchant's mobile video terminal 102 transmits the payment instruction and associated information confirmed by the payer to the third-party payment platform 107.
802—The security unit 103 of the third-party payment platform 107 automatically receives the payment instruction and associated information.
803—The system checks whether the payment instruction and associated information involves any credit-card payment or bank account transfer transaction.
804—If the result of the step 803 is “Yes”, the system transmits the payment instruction and associated information to the relevant bank for processing.
805—The bank system automatically receives the payment instruction and associated information. If the result of the step 803 is “No”, the system checks whether the payment information involves any merchant's special offer(s) as step 810.
806—According to the bank's procedures for internal processing of credit-card or bank account transfer transactions, the bank determines whether the transaction is successful.
807—If the result of the step 806 is “No”, the system sends a transaction failure message to the third-party payment platform 107.
808—If the result of the step 806 is “Yes”, the system sends a transaction confirmation message to the third party payment platform 107.
809—The third-party payment platform 107 records the transaction failure in the user transaction database 106.
810—The system checks whether the payment information involves any merchant's special offer(s).
811—The system displays transaction failure reason(s) on the merchant's mobile video terminal 102.
812—If the result of the step 810 is “Yes”, the system updates information of special offer(s) provided by the merchant in the user transaction database 106.
813—The payer reselects a payment method on the merchant's mobile video terminal 102.
814—The system updates transaction information of the merchant and the payer in the user transaction database 106.
815—Transaction success message is displayed on the merchant's mobile video terminal 102.
816—A short message is sent to the payer's mobile phone to acknowledge the transaction success.

The screen-displayed views seen by the user in a payment at the cashier using the payer's RFID card 100 (FIG. 9) comprises the following views.
901—When step 705 starts, the merchant's mobile video device 102 displays a view of a pattern diagram for input.
902—When step 712 starts, the merchant's mobile video terminal 102 displays a view of the payer's photo that is recently recorded, and a personal payment page.
903—When step 815 starts, the merchant's mobile video terminal 102 displays a view of transaction-successful confirmation.

When the system is used for on-line payment or phone payment, similar steps are performed to complete the payment. First, the payer provides a login name to the merchant through the merchant's online cash register 113 or the phone. Upon confirmation of the merchant's identity, the system sends a payment request and a pattern diagram to the payer's smart mobile device 101 that is registered. The payer enters an unlocking pattern in his or her smart mobile device 101, and takes a facial photo of himself or herself. After the system confirms the unlocking pattern is valid and the merchant (optionally) verifies the alikeness of the payer's facial appearance, the personal payment screen will appear on the payer's smart mobile device 101, so that the payer can choose a payment method and any special offer that is provided. Similarly, when the transaction is complete, the payer's registered smart mobile device 101 and the merchant's online cash register 113 will receive payment-successful confirmations.

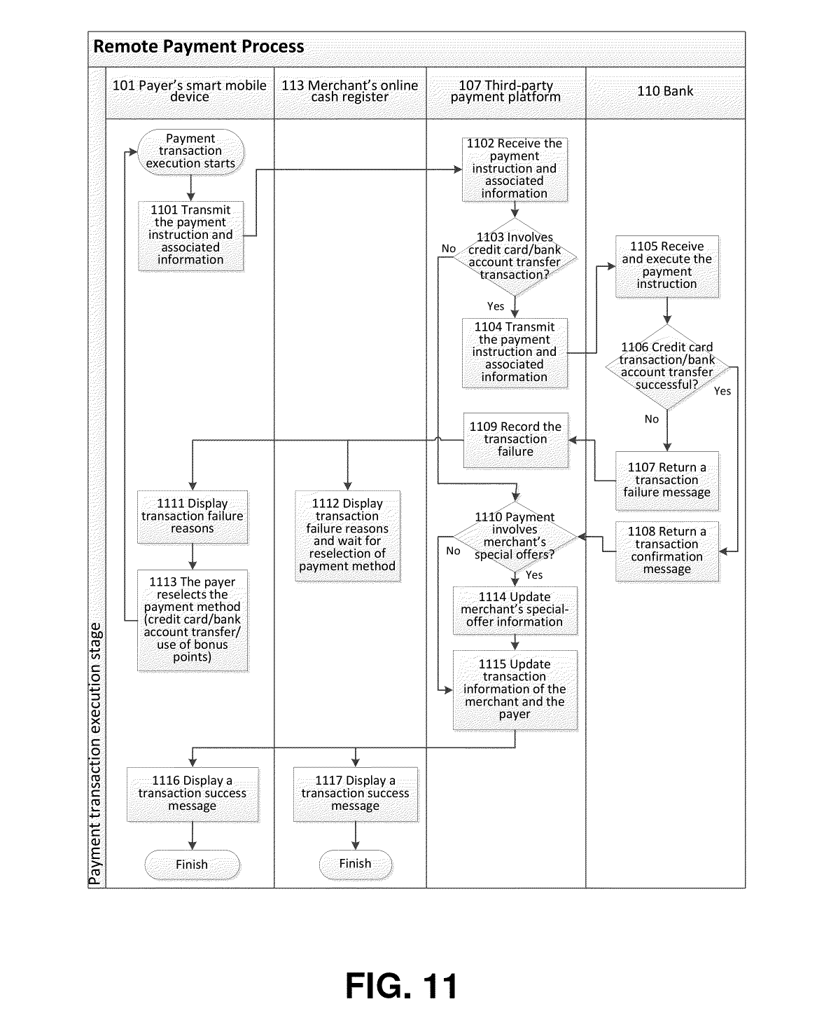

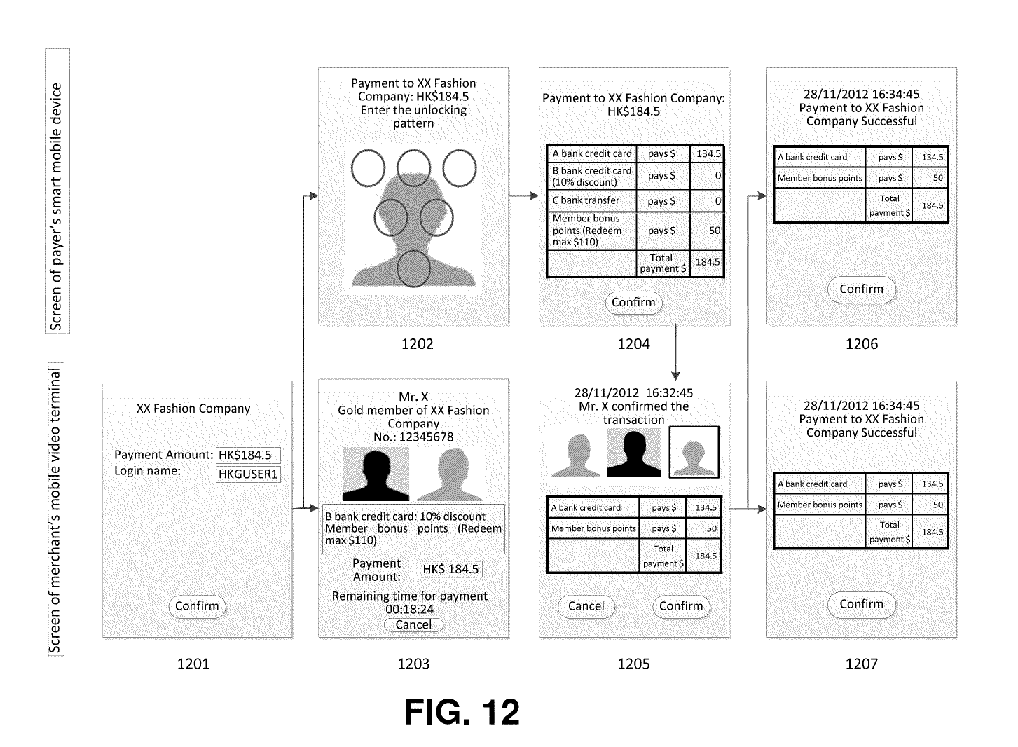

There are two stages in the process of making on-line payment or phone payment using payer's smart mobile device 101: the identity confirmation stage (FIG. 10); and the payment transaction execution stage (as indicated in FIG. 11). In these two stages, the screen-displayed views seen by the user is shown in FIG. 12.

The identity confirmation stage of making on-line payment or phone payment using payer's smart mobile device 101 (FIG. 10) comprises the following process.
1000—The merchant's online cash register 113 displays the payment amount and accepts manual input of the payer's login name.
1001—The merchant's online cash register 113 transmits merchant information, the payment amount and the payer's login name to the third-party payment platform 107.
1002—The security unit 103 of the third-party payment platform 107 checks the merchant information against the record(s) in the user transaction database 106 for merchant authentication.
1003—If the result of the step 1002 is “Yes”, the system fetches the information of the payer's smart mobile devices 101 from the record(s) stored in the user transaction database 106 by the payer's login name, and establishes a real-time data connection.
1004—If the result of the step 1003 is “successful”, the system records the payment instruction.
1020—The system displays record(s) of the payer's recent photos and the relevant membership status on the merchant's online cash register 113.
1005—The system sends a pattern diagram, preset by the payer, from the user transaction database 106 to the payer's smart mobile device 101.
1006—The payer enters an unlocking pattern on the smart mobile device 101 by moving the eye-tracking marker, or touching and drawing by a finger.
1007—The payer's smart mobile device 101 automatically takes a facial photo of the payer.
1008—The payer's smart mobile device 101 automatically transmits the payer's photo and the unlocking pattern to the security unit 103 of the third-party payment platform 107.
1009—The system checks the unlocking pattern entered by the payer against the one recorded in the user transaction database 106 for payer authentication.
1010—If the result of the step 1009 is “Yes”, the system will decide, according to the merchant's settings, whether to check the payer's current photo against previous photo records.
1018—If the result of the step 1009 is “No”, the system allows the payer to re-enter an unlocking pattern twice at most.
1011—If the result of the step 1010 is “Yes”, the system transmits the payer's photo and records of previous photo to the merchant's online cash register 113.
1012—The system displays the payer's current photo, recent records of previous photos and the membership status on the merchant's online cash register 113.
1013—The merchant determines, by naked eyes, if the payer's facial appearance in the current photo is similar to the recent records of the payer's previous photos.
1014—If the result of the step 1013 is “Yes” or the result of the step 1010 is “No”, the system sends the payment amount, the payer's information and applicable special offer(s) provided by the merchant to the payer's smart mobile device 101.
1019—If the result of the step 1013 is “No”, the merchant can decide whether or not to request a retake of the payer's current photo for further comparison.
1015—The payer's smart mobile device 101 displays the payment amount, the payment information and the applicable special offer(s).
1016—The payer selects a payment method and any special offer(s) on the smart mobile device 101, and confirms the transaction.
1017—If the result of any of the steps 1002, 1003 and 1019 is “No” or “Failed” or the result of the step 1018 is “Yes”, the third-party payment platform 107 will send a security control message, and reject the transaction.

The payment transaction execution stage of making on-line payment or phone payment using payer's smart mobile device 101 (FIG. 11) comprises the following process.
1101—The payer's smart mobile device 101 transmits the payment instruction and associated information confirmed by the payer to the third-party payment platform 107.
1102—The security unit 103 of the third-party payment platform 107 automatically receives the payment instruction and associated information.
1103—The system checks whether the payment information and the instruction involves any credit-card payment or bank-account transfer transaction.
1104—If the result of the step 1103 is “Yes”, the system transmits the payment instruction and associated information to the relevant bank for processing. If the result of the step 1103 “No”, the system checks whether the payment information involves any merchant's special offer(s) in step 1110.
1105—The bank system automatically receives the payment instruction and associated information.
1106—According to the bank's procedures for internal processing of credit-card or bank-account transfer transactions, the bank determines whether the transaction is successful.
1107—If the result of the step 1106 is “No”, the system returns a transaction failure message to the third-party payment platform 107.
1108—If the result of the step 1106 is “Yes”, the system returns a transaction confirmation message to the third party payment platform 107.
1109—The third-party payment platform 107 records the transaction failure in the user transaction database 106.
1110—The system checks whether the payment information involves any merchant's special offer(s).
1111—The system displays reason(s) of transaction failure on the payer's smart mobile device 101.
1112—The system displays reason(s) of transaction failure on the merchant's online cash register 113 and waits for reselection of the payment method.
1113—The payer reselects the payment method on the payer's smart mobile device 101.
1114—If the result of the step 1110 is “Yes”, the system updates the merchant special-offer information in the user transaction database 106.
1115—The system updates transaction data of the merchant and the payer in the user transaction database 106.
1116—Transaction success message is displayed on the payer's smart mobile device 101.
1117—Transaction success message is displayed on the merchant's online cash register 113.

The screen-displayed views seen by the user in on-line payment or phone payment using payer's smart mobile device 101 (FIG. 12) comprises the following views.
1201—When the step 1000 starts, the merchant's online cash register 113 displays a view of the payment amount and the payer's login name input.
1202—When the step 1006 starts, the payer's smart mobile device 101 displays a view of a pattern diagram for input.
1203—When the step 1020 starts, the merchant's online cash register 113 displays a view of record(s) of the payer's recent photos and the membership status.
1204—When the step 1015 starts, the payer's smart mobile device 101 displays a view of the personal payment page and the merchant's special offer(s).
1205—When the step 1012 starts, the merchant's online cash register 113 displays a view of the merchant's manually checking the payer's current facial appearance.
1206—When the step 1116 starts, the payer's smart mobile device 101 displays a view of transaction-successful confirmation.
1208—When the step 1117 starts, the merchant's online cash register 113 displays a view of transaction-successful confirmation.

After the payment transaction is completed in a manner as described above, previous payment records can be checked at any time by using the payment application software running on the registered smart mobile device 101. Each payment record is attached with the payer's photo for identity authentication.

In comparison to currently available techniques, the present invention has the following advantages:
1. The electronic-payment authentication process with an eye-positioning method for unlocking a pattern lock disclosed herein provides a very high security level achieved by triple-authentication process, regardless of whether the payment is made at physical retail sites or via online shops (such as via a phone or on the Internet). Said triple-authentication process includes a manual process verifying payer's facial appearance in order to prevent, in the absence of human monitoring, the payment account from being fraudulently used when both the payment equipment and the unlocking pattern are leaked out.
2. The electronic-payment authentication process with an eye-positioning method for unlocking a pattern lock disclosed herein offers operational simplicity and convenience greater than that offered by currently available card-based payment methods.
3. The payer only needs to carry a smart mobile device or an RFID card for the authentication process of the electronic-payment system disclosed herein.
4. Through the verification by the payment system disclosed herein for making a transaction, every payment record is attached with a photo of the payer taken at the time of making the transaction, greatly favor investigation to be conducted in case of theft.
5. The dual methods of entering an unlocking pattern as disclosed in the present invention can be implemented on electronic equipments having a digital camera and either a touch screen or a non-touch-based screen. Furthermore, the Payment Approval Code can be sent in form of a text, a two-dimensional barcode (i.e. Matrix Barcode) or via NFC (Near Field Communication). These features offer a high compatibility to hardware of various smart mobile devices.
6. The pattern diagram design approach as disclosed in the present invention allows the user to preset pattern diagrams with different degrees of complexity, so as to offer different security levels of the pattern lock.
7. The pattern diagram as disclosed in the present invention also allows the user to define which one of the eyes, i.e. the left eye or the right eye, to be used for entering the unlocking pattern, so as to reduce the chance of pattern peeping by nearby individuals.

What is claimed is:

1. An eye-positioning method for unlocking a pattern lock by a user, comprising:
showing to the user a pattern diagram on a display, wherein the pattern diagram is pre-stored in a storage device at a back-end server, and is transmitted to the display via a network;
capturing a real-time facial image of the user by a video-taking equipment coupled to the display;
a marker real-time tracking an eye of the user based on the facial image, enabling the marker to move on the pattern diagram to form a marker-movement path according to movement of the eye relative to the video-taking equipment, wherein the eye is either a left eye or a right eye as pre-agreed; and
determining if the marker-movement path includes an entirety of a pre-set action path, whereby the pattern lock is unlocked if a positive result is obtained in such determining.

2. The method of claim 1, wherein the pattern diagram comprises a plurality of rings, and wherein the user determines the number of the rings and a combination of the rings to form the pattern diagram.

3. The method of claim 2, wherein the marker-movement path is formed by hopping among the rings, hopping on any one of the rings with more than one time being allowable.

4. The method of claim 1, wherein the marker-movement path is alternatively formed by moving a finger on a touch screen incorporated in the display instead of being formed according to the movement of relative position between the eye and the video-taking equipment.

5. An electronic-payment authentication method, comprising:
establishing communication links among an electronic-payment user device, an electronic-payment system, and a financial institution;
determining, by the electronic-payment system, if a payer is registered to use the electronic-payment user device, in order to confirm the payer's identity and validity of a payment made by the payer;
transmitting a pattern diagram from the electronic-payment system to the electronic-payment user device, and requesting the payer to unlock a pattern lock associated with the pattern diagram in order to further confirm the payer's identity, wherein the pattern diagram is pre-stored in the electronic-payment system and is displayed on the electronic-payment user device; and
unlocking, by the payer, the pattern lock according to the method of claim 1, wherein the payer is regarded as the user.

6. The method of claim 5, further comprising:
after the payer's identity and the validity of a payment made by the payer are confirmed, comparing, by a merchant, the payer's actual facial appearance against the payer's recent photos as recorded in the electronic-payment system, in order to further confirm the payer's identity.

7. The method of claim 5, wherein the electronic-payment user device is:
a smart mobile device used by the payer to make a payment at a physical retail site, via a phone call or on the Internet; or
a Radio-Frequency Identification (RFID) card that supports reading and writing of RFID Card Number stored therein, the RFID card being used by the payer to make a payment at a physical retail site.

8. The method of claim 7, wherein the electronic-payment user device is a smart phone or a tablet computer.

9. The method of claim 7, wherein, if the smart mobile device is used as the electronic-payment user device to make a payment at a physical retail site, the electronic-payment user device is enabled to generate, by software, a Payment Approval Code, which is computed by using a regularly-changed asymmetric key pair to encrypt and decrypt a composite data set formed according to the payer's identity, and time and date of encryption, so as to enable the electronic-payment system to approve the payment if:
successful decryption is achieved;
the payer's identity matches a corresponding record in the electronic-payment system; and
the time and date of encryption are not expired.

10. The method of claim 7, wherein the RFID Card Number includes a payer identification number stored in the RFID card, and a serial number configured to be regularly updated by the electronic-payment system each time when any merchant's mobile video terminal senses the RFID card, so as to enable the electronic-payment system to approve the payment if both the payer identification number and the serial number match corresponding records of the electronic-payment system.

11. The method of claim 7, wherein, when the smart mobile device is used as the electronic-payment user device at the physical retail site, the Payment Approval Code is transmitted from the smart mobile device to the physical retail site's side by means of a text, by a two-dimensional barcode or through NFC (Near Field Communication).

12. The method of claim 6, wherein the payer's recent photos were recorded by the electronic-payment system when the payer made one or more previous payments.

13. The method of claim 5, wherein each payment record in the electronic-payment system is attached with the payer's photo for identification and for use in theft investigation.

14. The method of claim 5, wherein:
the video-taking equipment is coupled to the electronic-payment user device, the video-taking equipment being used for video-taking the payer's facial appearance; and
the electronic-payment user device includes an eye-tracking control module, the eye-tracking control module being configured to detect the eye's position by an object-recognition algorithm according to the payer's facial appearance obtained by the video-taking equipment such that the marker's position on screen is determined by the eye's position in the captured image.
